(19) United States
(12) Patent Application Publication
(10) Pub. No.: US 2012/0206644 A1
(43) Pub. Date: Aug. 16, 2012

(54) Camera LCD Screen Sliding Shield Door

(76) Inventor: Babak Enayati, Los Angeles, CA (US)

(21) Appl. No.: 13/351,299

(22) Filed: Jan. 17, 2012

Related U.S. Application Data
(60) Provisional application No. 61/463,178, filed on Feb. 14, 2011.

(51) Int. Cl. H04N 5/225

(52) U.S. Cl. 348/373; 348/E05.026

(57) ABSTRACT

A protective device to protect LCD screens of digital cameras, as well as other electronic devices and peripherals. A protective sliding shield door protects the LCD screen from physical damage. The shield door is a flexible door that is molded to fit around the outside of a given LCD screen, and subsequently slides through two opposing guiding tracks to reach two opposing bays. A locking mechanism enables the door to retain a closed position when the device is not in use. An adhesive substance enables permanent attachment, and a bottom extension containing a threaded screw enable removable attachment, by fastening to the threaded mounting hole of a camera.

### CROSS-REFERENCE TO RELATED APPLICATIONS

This application claims the benefit of provisional patent application Camera LCD Screen Sliding Shield Door, Ser. No. 61/463,178, filed Feb. 14, 2011 by the present inventor, which is incorporated by reference.

### BACKGROUND OF THE INVENTION

With the onset of digital cameras and the rise of the digital revolution, modern photography has entered upon a new age, the digital age. Gone are the days of film reels, having been replaced by digital files created by microprocessors. Consequently, antiquated film technology has been rendered obsolete, and in turn has spawned new innovation and implementations, notably the Liquid Crystal Display screen, known colloquially as the LCD screen. The LCD screen is now equipped on virtually all digital cameras as a standard issue multi-purpose device, and its purposes include viewing photos and videos that have already been taken, as well as functioning as a digital viewfinder to observe the field of view, prior to taking photographs and video.

The implementation of such new technologies like the LCD screen in cameras and other electronic devices and peripherals necessitates further issues and needs that must subsequently be addressed and resolved. One such issue is the protection of the LCD screen from physical damage from external factors, such as falling from a user's hands, coming into contact with other equipment, colliding with other objects, and exposure to the elements. It is a commonly recurring phenomenon to photographers on all skill levels that during the course of photography, LCD screens often suffer and incur damage including but not limited to scratching, cracking, breaking, and dust accumulation, among other undesired occurrences.

Such damage is detrimental to a device such as a camera, and is oftentimes unforeseeable, and can still occur even during nonuse of the camera, for instance during storage and transport of the camera, when it is in a backpack or a case. Even with due diligence and care, accidental damage still occurs, and it is therefore necessary and imperative to protect the LCD screen from any sort of damage that can potentially occur.

### PRIOR ART

None of the following cited works are believed to detract from the patentability of the claimed embodiments of the invention. The most common solution that is used to attempt to resolve the previously stated issues concerning potential damage to an LCD screen is to use a clear colored cover to wrap around the LCD screen. Frequently, these covers do not operate well, as they themselves receive the scratches, nicks, and cracks that the LCD screen would have been receiving, which consequently results in view distortion of the given matter on the LCD screen. Moreover, such covers often reduce and impair visibility of matter on the LCD screen, and hamper clear viewing, even when first installed in new condition, due to the fact that there is simply an extra layer on top of the LCD screen, in addition to the fact that they are reflective, and oftentimes glossy.

After these covers accumulate such damage over the course of use, they are oftentimes replaced. This proves to be a daunting task, and can be time consuming, uncomfortable, and prove to be a general nuisance, as doing so requires the removal of the existing screen. Covers such as these are typically bonded to the camera with adhesive substances, and removal subsequently requires care and patience to properly detach such a cover off. Certain models snap on to the camera, but can easily detach from the camera, and often do. Either way, the process requires the purchase of an additional cover replacement, as well as reconfiguration and emplacement of such a replacement cover back on to the LCD screen, which is another added inconvenience.

Other attempted solutions include utilizing thin removable films which are used to cover LCD screens. These films do relatively little to protect the LCD screen from physical damage, such as falls, blunt force, and deep penetrating scratches, and only serve to protect the LCD screen from less intense elements, such as rough handling, dust accumulation, aquatic exposure, and airborne particles.

Although such films often do not require any sort of adhesive bond to attach to the LCD screen, they still do not afford the adequate protection that their thicker counterparts at least offer. Ultimately, these thin films do not resolve the issue of fully protecting the LCD screen from all potential damage, namely from intense outside elements and factors, and accordingly, do not provide satisfactory results regarding this issue.

Further attempts in resolving the issue of adequately protecting the LCD screen include digital camera LCD screen protector devices that utilize pop up mechanisms. Such devices have a frame assembly which covers an LCD screen, which attaches to a camera body. Another frame is fastened to the assembly, which protrudes out once opened. With the assistance of springs, two rotatable hinges maneuver through a guiding groove that is on the frame, enabling the frame to pop out. Once fastened to a camera and in the opened position, the device is utilized as a glare guard, and remains open in order for a user to view matter on the LCD screen, but is folded shut in order for a user to properly resume viewing matter through the camera's viewfinder, since the frame is not in the way of the user.

Drawbacks such as these limit the functionality and efficiency of an efficient LCD protective device, particularly while viewing matter on the LCD screen. This is chiefly due to the protruding hinges of the device which project out, blatantly getting in the way of the user, by becoming a very inconvenient obstruction that is emplaced between the user and the viewfinder, among other components. This is also potentially dangerous, and can result in physical harm to a user, being that the user's eyes are so close to the hinges when viewing, and ensuing injury can easily occur.

Although the hinges do serve the purpose of limiting glare when left in an open position exposing the LCD screen, they cannot however be left in an open position when a user wants to revert back to gauging the field of view through the viewfinder to take a photograph, and need to be folded shut in order to preserve a comfortable manner in which to shoot photographs without any hindrance.

This downfall ultimately results in time being wasted performing the monotonous function of opening and closing the hinges for viewing. This downfall can especially be cumbersome and counterproductive when a user takes numerous photos successively in adjacent intervals of time. In this all too familiar scenario, the user has to engage in a tiring routine where he or she must consistently close the hinges, look through the viewfinder, shoot the photo, open the hinges, view the photo on the LCD screen, and then revert to close the hinges again, repeatedly, in a continuous, repetitive set of motion. Such repeated motion also greatly reduces the life expectancy of the device, and is an excellent way to wear out the assembly. Ultimately, such a device offers a nontraditional method to view matter on the LCD screen, which likewise adds to a state that is not comfortable to the user. In addition, due to the fact that there are springs and hinges in the assembly, I have found that these parts are prone to accelerated wear, and very easily wear and break apart over the course of use. Such poor workmanship renders the quality of the device as inferior and problem prone, and is an overall nuisance. Finally, the irritating, cumbersome design of the device far outweighs its benefits of use.

Additional attempts to resolve the issue of protecting the LCD screen include similar digital camera LCD screen protector devices, offering several various methods to do so. Certain variations of such protector devices include a frame that attaches to an LCD screen that utilizes a clear, transparent cover, but such a cover stills falls victim to the same issues and susceptibilities as do the conventional plastic covers, in that they can still receive the same physical damages including but not limited to cracking, breaking, and dust accumulation, and consequently impair proper viewing of matter on the LCD screen, being that the cover itself is not protected, and would receive such damage.

An auxiliary device includes a supplemental glare reduction device, similar to the pop up device, but is removable, having the ability to be attached and detached from the main protector device. Despite the removable ability, because it protrudes outwards, the glare reduction device still consequently falls victim to the same issues and concerns as does the pop up protector device, namely that it is a cumbersome obstruction which gets in the way of the user during camera use, and disrupts normal, comfortable operation. There are additional removable devices, which offer a way to eliminate screen glare, as well as protect against scratching of the LCD screen, such as camera LCD screen hood viewing devices. Such devices contain a removable hood that goes over an LCD screen of a digital camera. The device attempts to eliminate glare, but is still removable, and as a result, allows for potential damage to the LCD screen to occur when not in use. Moreover, the extra protruding space that the device occupies creates a fairly large buffer, which interposes itself between the user and the camera.

This obstruction makes conventional use of the camera difficult. The use of the device makes simple actions such as walking with the camera, looking through the viewfinder, and taking pictures with the camera now extremely awkward and uncomfortable, and like the afore mentioned pop up protector device and other digital camera LCD screen protector devices, the LCD screen hood viewing devices offer a non comfortable approach to protect the LCD screen which is cumbersome, bulky, and inconvenient.

In addition, the fact that the hood is such a large obstruction makes it an extremely poor choice to serve as a non-removable solution for a protective device which can be permanently fixated to the camera. Although there are versions which utilize straps to attach the device to a camera, the setup is extremely cumbersome and awkward, due to the enormous obstruction which the device creates, which is now permanent. While the LCD screen is protected, a user who wants to engage in the normal use and operation of the camera cannot do so, due to the large hindrance which the device occupies.

An additional concern regarding the large protruding space of the device is that it disables the effective usefulness of such a permanently mounted scenario to occur, namely since the camera that the device attaches to will not be able to fit in a standard case, and larger cases would have to be purchased and used. Finally, even in the case where the hood device is used in a removable scenario, which severely limits the purpose of protecting an LCD screen to begin with, the fact that the device occupies such a large protruding space creates the necessity to have additional carrying and stowing space dedicated to the device.

The devices of the prior art mentioned herein have all made attempts to resolve the issue of protecting an LCD screen from damage by external factors, forces, substances, and elements, but all have their own shortcomings, faults, limitations, and failures. Ultimately, these flaws are not trivial, and severely limit the usefulness, efficiency, and effectiveness of the purported secondary functions and purposes, as well as the primary function of protecting an LCD screen in such devices.

That being said, the principal needs are for a protective device that is effective in fully protecting an LCD screen of a given electronic device from physical damage by external factors, forces, elements, and substances, such as dust particles and scratches. Furthermore, the device itself needs to be resilient enough to sustain and uphold such damage, and for that damage sustained to not impair, hamper, or distort viewing of matter on the LCD screen. The device should be made of a durable material that can withstand such rugged use, and should be well made with parts that do not easily wear and tear over use.

Moreover, there is a need for such a device to be reasonably sized, both in physical size and appearance, and for it not to be bulky, excessively large, or cumbersome, nor for it to be so excessive in form so that it will be an inconvenience to a user. In addition, the device must not interfere in the normal operation of actions which are typical in the use of photography and electronics, and its presence on a given device should accordingly not create a sense of awkwardness or discomfort. It should not obstruct any parts or uses, and its operation should ideally be, in a best case scenario, one in which there will be relatively little noticeable difference of operation, had the device not been present on an electronic device, versus it being there. Finally, the device should not require any additional space for storage, in that it should not require the use of additional cases, bags, or other mediums of storage when attached to an electronic device in question, such as a camera. In contrast, the electronic device in question should ideally be able to fit in the standard storage medium in which it was originally allotted and intended to be placed in, even with such a protective device still attached to it.

### ADVANTAGES

The present embodiments of this invention help resolve the issue of adequately protecting an LCD screen of an electronic device from potential damage. The embodiments protect the LCD screen from potential damage in a novel way, by serving as a protective device which can be fixated on to an LCD screen. Moreover, it allows for a comfortable ease of use without any interference, obstruction, or inconvenience to a given user. Most importantly, by the nature of the working of the embodiments, it does not refrain or block the user from the ability to shoot photographs, gauge the field of view through the viewfinder, or view matter on the LCD screen. It also does not require any removal of any parts once fastened, to ensure a normal and efficient operation. Finally, the embodiments of the invention offer substantially improved workmanship, being that a rollable door is utilized, which is relatively resilient and resistant to wear and tear, and also due to the fact that there are no springs or hinges present, which are prone to wear and tear, and are susceptible to incur damage during the course of use. These and other advantages will become apparent upon reviewing the ensuing description and drawings.

### SUMMARY OF THE INVENTION

LCD screens have now become standard in the photographic and digital world. The LCD screen is a very expensive and integral component for digital cameras, and is as fragile as it is vital. During use, it is therefore necessary to protect the LCD screen from damage. In the art of photography, as well as other electronic mediums, it is known that LCD screens tend to sustain damage during the lifetime of the embedded equipment. Water, dust, fingerprints, scratches, cracks, and a host of numerous other damages can occur while in the field of photography, as well as during nonuse.

The embodiments of this invention prevent such undesired incidents from occurring, and resolve the issue of leaving the vulnerable LCD screen unprotected, whilst offering a comfortable way in which to do so, in that the device does not hinder or impair typical actions which occur during the use of LCD screens. The device additionally does not have any drastic size and space requirements to impede normal use of a camera equipped with the device, nor during storage of such a camera equipped with the device. It is also superior, due to the fact that it does not physically get in the way of a user and obstruct typical actions which occur during the use of a camera, such as gauging the field of view in the viewfinder, as well as viewing matter on an LCD screen at any given point of time. Thus, the primary objective of the embodiments of the invention is to protect an LCD screen, by utilizing a door that acts as a shield, which protects an LCD screen, while being utilized without relatively great effort, and including an operation that does not serve as a hindrance to a user.

The device includes a frame assembly which has a front side and a rear side, as well as left and right guiding track members, and an upper and lower receiving bay. The shield door moves through a left side guiding track member having upper and lower ends, as well as a right side guiding track member having upper and lower ends. Both guiding track members contain slots which enable the door to move through them, and are constructed so that the rollable shield door will not come into physical contact with the LCD screen. The guiding track members curve gently downward at a slope at their ends, so that the rollable shield door slides into either of two bays, which receive the door.

The shield door is fully housed in an upper receiving bay, which is connected to the left and right guiding track members. It fully receives the shield door by reeling it in when it is slid inside of it, and is retracted. A lower receiving bay is additionally connected between the left and right guiding track members, and its purpose is to dock with the door when it is in a fully closed position. Both bays contain a set of opposing slots, which enable the shield door to enter inside of them. In the upper receiving bay, the door subsequently continues to an internal track, which contains the shield door when it is slid inside of it, thereby exposing the LCD screen. This assembly thus works fluidly in tandem, to enable proper movement of the door.

The rollable shield door is a door that has left and right sides and upper and lower ends, and moves through the guiding track members by the left and right sides, to an open and closed position. The shield door contains a handle on the front side, which enables a user to properly move the door through the guiding track members.

In an embodiment, a lock is mounted to the shield door, with a sliding deadbolt locking bar that slides to a corresponding aperture, either a receiving cap or a slot, to a locked and unlocked position. It is ideally utilized when the shield door is docked to the lower receiving bay, and in a closed position. Its purpose is to assist in stabilizing the position of the door, so that the door is less likely to inadvertently open. In another embodiment, a clear protective sheet is mounted beneath the shield door, between the two guiding track members. This is done to enable an extra layer of added protection for the LCD screen, and its primary purpose is to protect the screen from factors such as dust particles and aquatic elements, when the shield door is open.

The frame assembly is connected to the electronic device in two embodiments. The first is by an adhesive, whereby an adhesive substance is placed on the rear of the assembly, to be attached to an electronic device. This enables a substantially more permanent application, if desired. The second embodiment includes a bottom extension, which is connected to the lower receiving bay. A lock screw screws into an existing mounting hole of the electronic device, and completes a thorough attachment. This additionally allows for the frame assembly to be attached without sacrificing the ability to connect to a support such as a tripod, as the screw contains a threaded shaft which mimics the original existing threaded shaft.

The preceding features and advantages of the embodiments of the invention will be more fully understood from the following drawings, in conjunction with the accompanying detailed description.

### BRIEF DESCRIPTION OF THE DRAWINGS

FIG. 1 is a frontal view of a digital camera fitted with the present invention, with the sliding shield door covering the LCD screen of a camera, in a closed position.

FIG. 2 is a frontal view of the same digital camera fitted with the present invention, whereby the sliding shield door is positioned in the open position, revealing the LCD screen.

FIG. 3 is a perspective view of an embodiment of a fixated protruding handle that it attached to the sliding shield door, to enable precise movement of the door.

FIG. 4 is a side view of one of the two guiding tracks which guides the sliding shield door, enabling the door to maneuver.

FIG. 5 is a cutaway view of the right guiding track.

FIG. 6 is a perspective view of the frame assembly, as well as the two opposing guiding tracks, situated with two respective slotted bays.

FIG. 7 is a partial perspective view of the two opposing guiding tracks and the shield door, demonstrating direction of movement of the door.

FIG. 8 is a perspective view of the two slotted bays and the shield door, fitted over the LCD screen, in an open position.

FIG. 9A is an exploded view of an alternative embodiment, where a clear transparent layer is fitted beneath the shield door, covering the LCD screen.

FIG. 9B is a perspective view of the alternative embodiment of the clear transparent layer, situated beneath the two opposing guiding tracks, and the two receiving bays.

FIG. 9C is a frontal view of a digital camera with a recessed handle embodiment fitted over the sliding shield door which is covering the LCD screen of the camera, in a closed position.

FIG. 9D is a frontal view of the recessed handle and the sliding shield door.

FIG. 9E is a perspective view of the recessed handle and the sliding shield door.

FIGS. 10A-10C are various views of the lower receiving bay, with emphasis on the slot in relation to the sliding shield door.

FIGS. 11-11C are various views of the upper receiving bay, with emphasis on the slot in relation to the sliding shield door.

FIG. 12 is an exploded cutaway view of the internal track in the upper receiving bay, which has been bisected, and the two guiding track bodies.

FIG. 13 is a cutaway view of the internal track and the upper receiving bay, and the shield door, demonstrating the manner of movement.

FIG. 14 is a cutaway view of the same internal track in FIG. 13.

FIG. 15 is a perspective view of both sides of the shield door.

FIG. 16A is a perspective view of the orientation of the individual slats of the shield door.

FIG. 16B is an exploded cutaway view of an alternative simple track embodiment in the upper receiving bay which has been bisected, with a rod, a simple track, the two guiding track bodies, and the sliding shield door.

FIG. 16C is a perspective view of the simple track embodiment, with a rod attached to the sliding shield door.

FIG. 16D is a side view of the simple track embodiment, with the sliding shield door coiled up.

FIGS. 17A-17B are various views of an embodiment of a locking mechanism, with a sliding deadbolt and a receiving cap.

FIG. 18A is a perspective view of the sliding shield door docked with the lower receiving bay, with the sliding deadbolt in the locked position, locked with the receiving cap.

FIG. 18B is a perspective view of the sliding shield door in an open position, with the sliding deadbolt in an unlocked position.

FIG. 19 is an exploded perspective view of an embodiment, with the sliding deadbolt fixated onto a raised platform.

FIG. 20A is the same frontal view as FIG. 1 with the locking mechanism in the locked position.

FIG. 20B is the same frontal view as FIG. 2 with the locking mechanism in the unlocked position.

FIGS. 21A-21B are various views of an alternative embodiment of a locking mechanism, with a simple sliding deadbolt.

FIG. 22A is a perspective view of the sliding shield door docked with the lower receiving bay, with the simple sliding deadbolt in the locked position, locked under the right guiding track.

FIG. 22B is a perspective view of the sliding shield door in an open position, with the simple sliding deadbolt in an unlocked position.

FIG. 23 is an exploded perspective view of a deep insertion slot within the right guiding track, demonstrating the path of insertion for the simple sliding deadbolt.

FIG. 24A is the same frontal view as FIG. 1 with the alternative embodiment of the locking mechanism, in the locked position.

FIG. 24B is the same frontal view as FIG. 2 with the alternative embodiment of the locking mechanism, in the unlocked position.

FIG. 25A is a perspective view of an embodiment of a lock screw.

FIG. 25B is a perspective view of three positions of a rotatable handle of the lock screw.

FIG. 26 is a perspective view of an attachment extension embodiment attached to a camera, which includes a lock screw and an auxiliary mounting hole, in addition to illustrating the method of attaching a support screw to a support.

FIG. 27 is an exploded bottom view of a camera with the attachment extension embodiment shown in FIG. 26.

FIG. 28 is a bottom view of a camera fastened to the attachment extension embodiment.

FIG. 29 is a perspective view of the attachment extension embodiment, as well as the attachment extension embodiment fastened to a camera, illustrating the method of attachment.

FIG. 30 is a perspective view of an embodiment of a mounting screw adapter.

FIG. 31 is an exploded view of a camera, the mounting screw adapter, and a support screw, illustrating the order and method of attachment.

FIG. 32 is an exploded bottom view of a camera and an alternative attachment extension embodiment.

FIG. 33 is a bottom view of a camera fastened to the alternative attachment extension embodiment.

FIG. 34 is a perspective view of the alternative attachment extension embodiment, as well as the alternative attachment extension embodiment fastened to a camera, illustrating the method of attachment.

FIG. 35 is a perspective view of a camera fitted with the device while attached to a support, ultimately utilized either way in both attachment extension embodiment scenarios.

FIG. 36A is a rear view of the frame assembly fitted with an adhesive attachment embodiment.

FIG. 36B is a frontal view of the frame assembly.

FIG. 37 is a perspective view of the adhesive attachment embodiment, as well as the adhesive attachment embodiment fastened to a camera, illustrating the method of attachment.

REFERENCE NUMERALS

| | | | |
|---|---|---|---|
| 1 | Camera | 20 | Layer |
| 2 | LCD screen | 21 | Sliding deadbolt |
| 3 | Protruding handle | 22 | Receiving cap |
| 4 | Sliding shield door | 23 | Elevated platform |
| 5 | Upper receiving bay | 24 | Simple sliding deadbolt |
| 6 | Lower receiving bay | 25 | Slot |
| 7L | Left guiding track body | 30 | Bottom extension |
| 7R | Right guiding track body | 31 | Lock screw |
| 8L | Left guiding track | 32 | Auxiliary mounting hole |
| 8R | Right guiding track | 33 | Mounting screw adapter |
| 9 | Slot | 35 | Adhesive substance |
| 10 | Slot | 40 | Support screw |
| 11 | Internal track | 41 | Support |
| 12 | Rod | 50 | Mounting hole |
| 13 | Simple track | 60 | Recessed handle |
| 70 | Frame assembly | | |

### DETAILED DESCRIPTION OF THE INVENTION

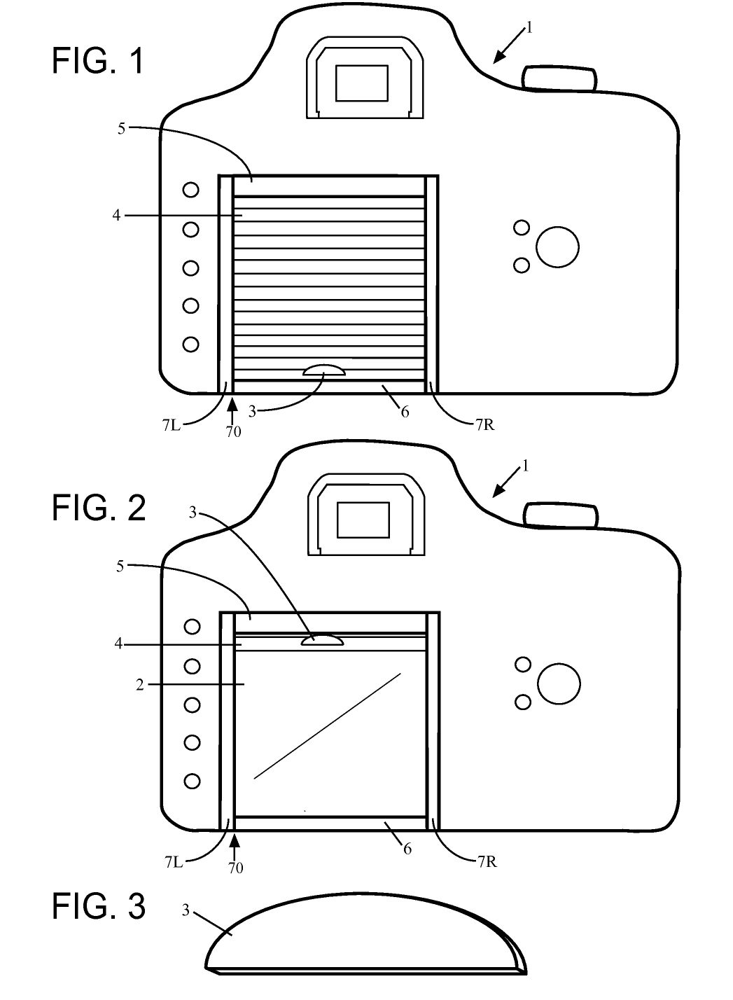

Proceeding first with FIG. 1, the camera LCD screen sliding shield door device is present, with the frame assembly 70 affixed to a camera 1, which includes a rollable shield door 4, which moves through guiding tracks 8L & 8R respectively. The frame assembly 70 of the device is molded to wrap around an LCD screen 2. It is attached to the body of a camera 1 or an electronic device so that as it enables the device to be fixated securely on to such a body.

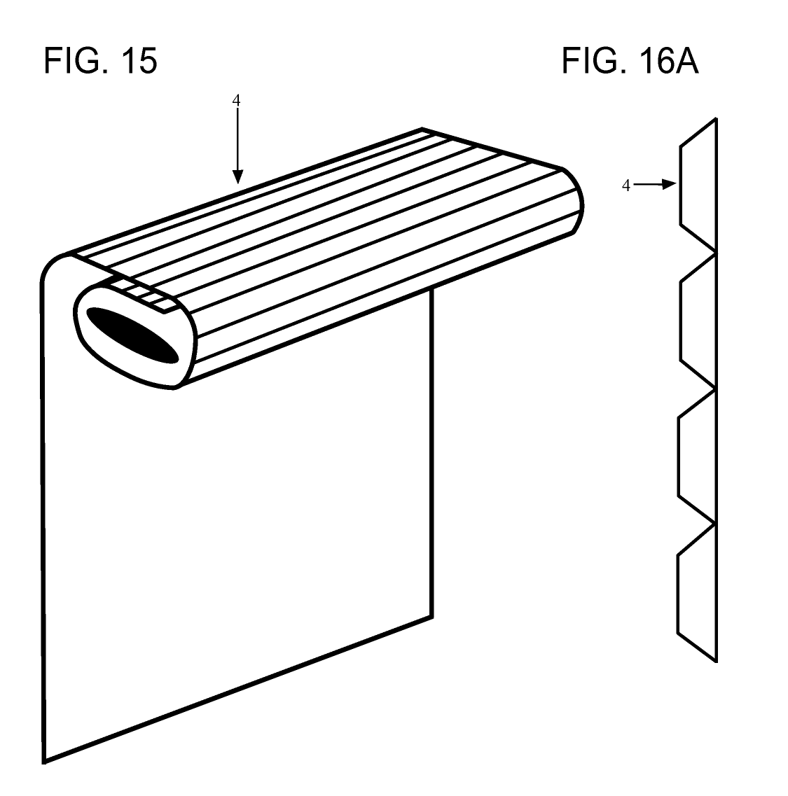

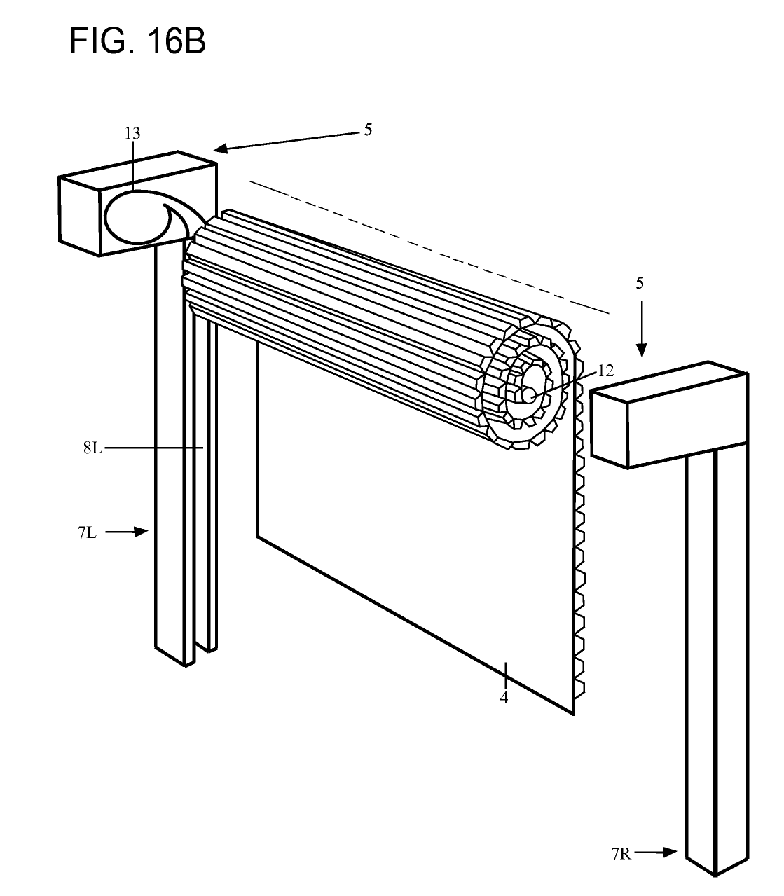

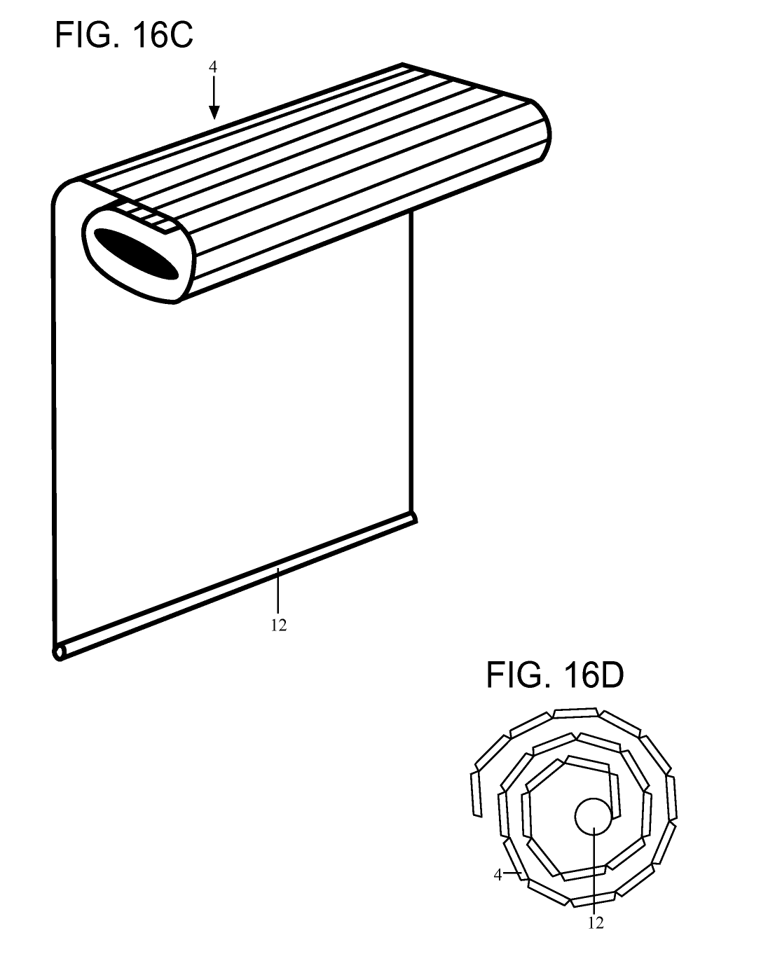

The sliding shield door 4 is a flexible door, preferably made of a durable plastic, although other similar flexible, pliable, and rollable sheet material such as flexible plastic, rubber, or elastomeric sheet material, for example, that can be rolled or enfolded upon itself, may also be suitable. As shown in FIGS. 15-16A, the sliding shield door 4 is made of a pliable yet durable material, and will be a flexible door that is either a single scored piece, or is composed of individual slats joined together and bound by a backing, thereafter being a single piece. The sliding shield door 4 is advantageously rollable, and is a rollable shield door.

The sliding shield door 4 slides through two opposing guiding tracks 8L&8R, which are made at a height so that the shield door 4 will not come into physical contact with the LCD screen 2. The guiding tracks 8L&8R curve gently downward at a slope at their ends, so that the shield door 4 slides into either of two bays 5&6, which receive the door 4. Both guiding tracks 8L & 8R are constructed into guiding track bodies 7L & 7R, which are square structures made of a durable material, for instance, a plastic or a metal. A protruding handle 3 is attached to the outside of the door 4, allowing the door 4 to roll along guiding tracks 8L&8R into the two opposing bays 5&6. Protruding handle 3 can also be molded to the shield door 4, which allows for the door 4 to be maneuvered.

As shown in FIG. 1, the shield door 4 is in a locked position, docking with a lower receiving bay 6. FIG. 2 continues the same embodiment with the door 4 being in the open position, docked with upper receiving bay 5. It too is made of a durable material, for instance, a plastic or a metal.

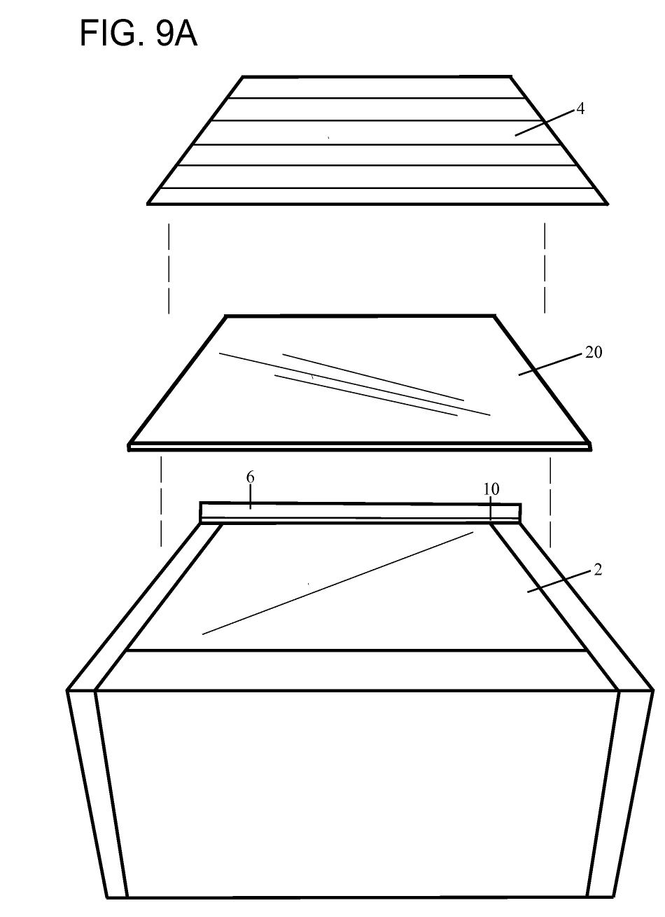

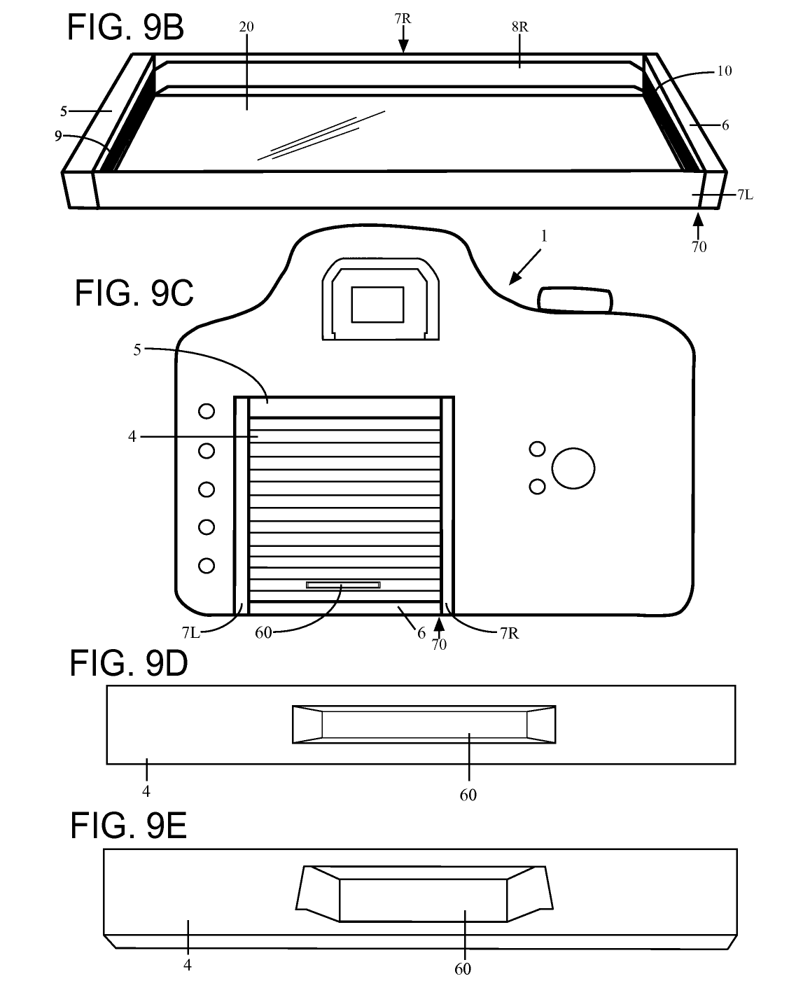

FIG. 9A illustrates another embodiment of the present invention, where a clear, transparent layer 20 is fitted beneath the shield door 4 as an additional layer of protection in the device, while still allowing for viewing of matter on the LCD screen 2 while the door 4 is in the open position. The layer 20 is additionally fitted beneath the shield door 4 and track portion of guiding tracks 8L & 8R, so as not to interfere with movement of the door or any other parts, as shown in FIG. 9B. The purpose of the embodiment is to accommodate for preferred additional protection of the LCD screen 2. The clear, transparent layer 20 is preferably made of a durable plastic or glass, but will not be limited to such materials, and any similar suitable transparent material will suffice.

A recessed handle embodiment is shown in FIGS. 9C-9E, with a recessed handle 60 affixed to the door 4. The recessed handle 60 is molded in the shield door 4, and enables an easier handling approach of movement that is less susceptible to breaking off of the door 4, being that it is carved in to the door 4. The recessed handle 60 is made of a durable material, for instance a plastic or a metal, and is preferably made of the same material as door 4.

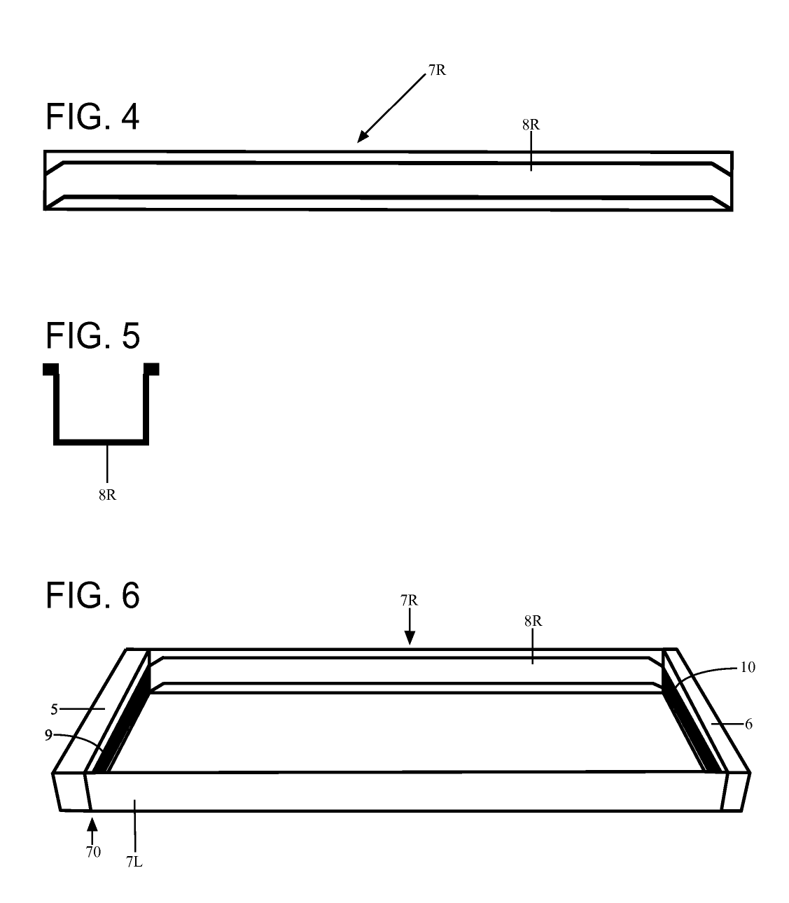

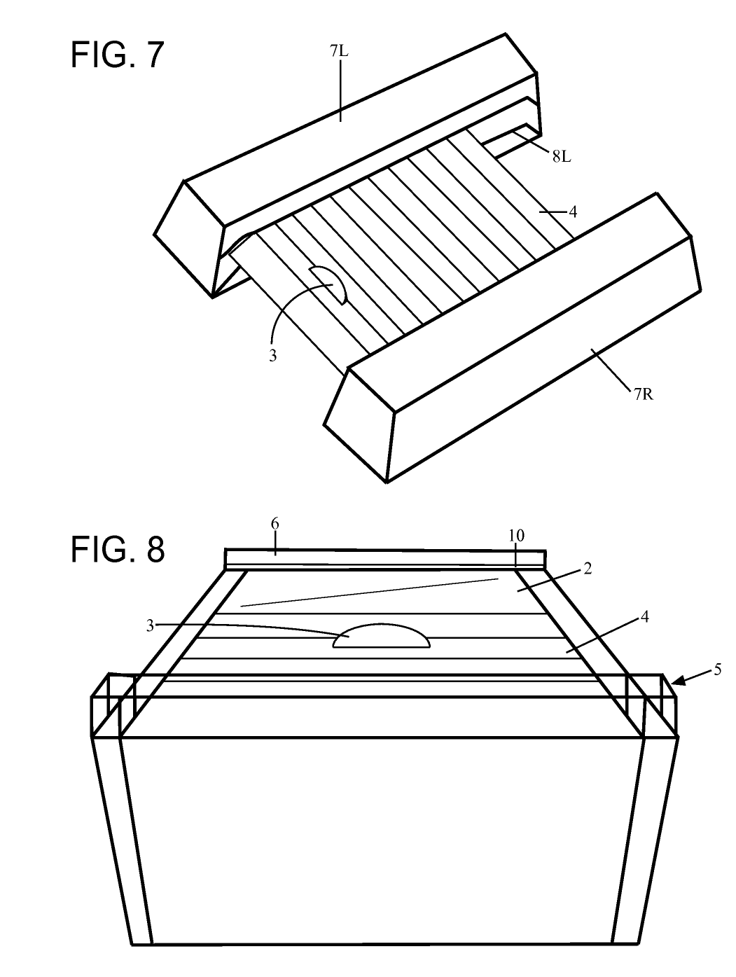

A side view of the right guiding track body 7R is shown in FIG. 4, which is identical to left guiding track body 7L. Both tracks 8L & 8R are straight for their near entireties, as depicted in FIGS. 4-7 & 12, and curve downwards at the ends of both of their respective tracks, on each side. This allows for smooth gliding movement of the sliding shield door 4 to reach its final destination, which of course is either of the two receiving bays 5 & 6, located on the two opposing sides of the frame assembly 70, which is visible in FIGS. 6 & 8.

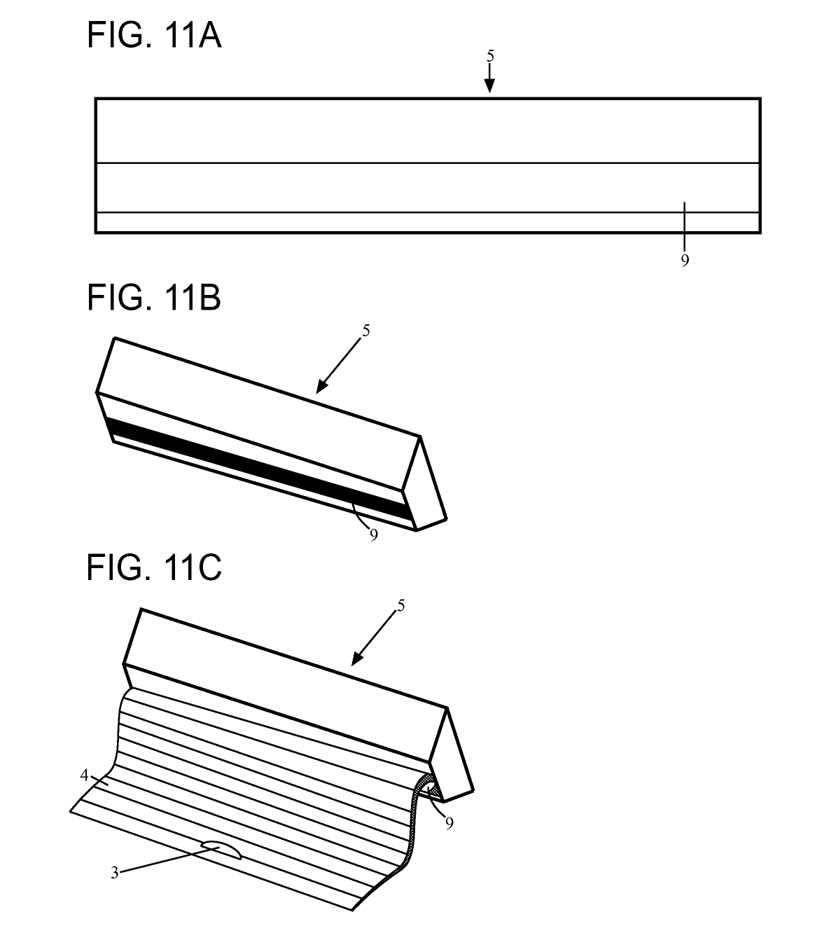

On one end of the guiding track bodies 7L&7R is the upper receiving bay 5, a structure that spans the width of coverage necessary to cover the LCD screen 2. Like guiding track bodies 7L &7R, it is made of a durable material, such as a plastic or a metal, but is not limited to such materials, and similar suitable materials can be used. The purpose of the bay 5 is to retain and receive the door 4 by reeling it in when it is slid inside of it. The bay 5 has a slot in its center, allowing for the door 4 to enter, and subsequently proceed to the internal track 11, which is included inside. The internal track 11 is fixated inside of the bay 5, and serves to contain the door 4 when it is slid inside of it, exposing the LCD screen 2. FIGS. 11A-11C illustrate various views of the upper receiving bay 5, a square, with a slot 9 in the center, enabling the shield door 4 to enter, to assume a fully opened position, revealing the LCD screen 2.

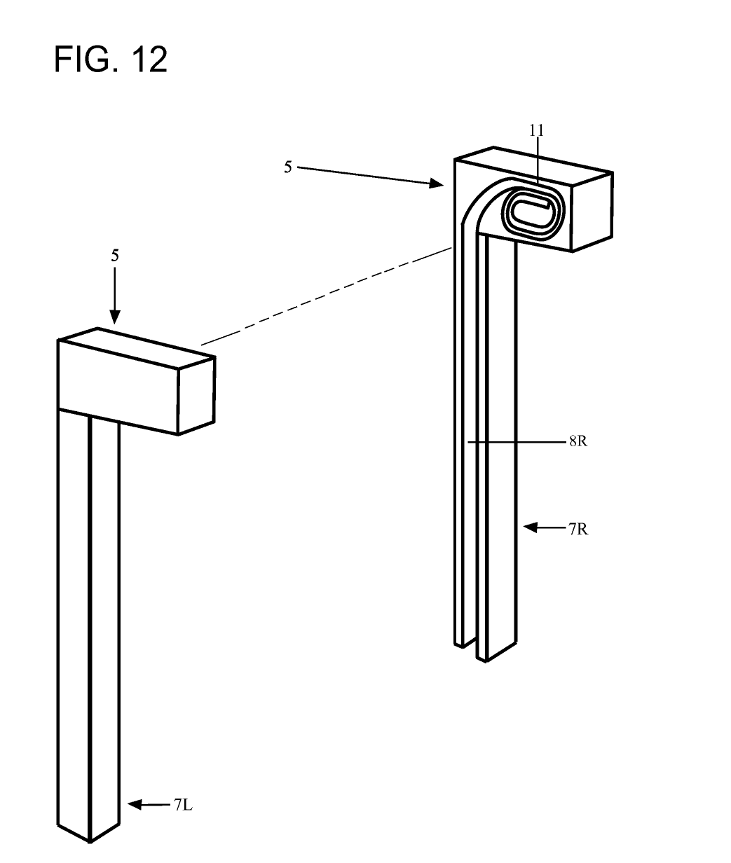

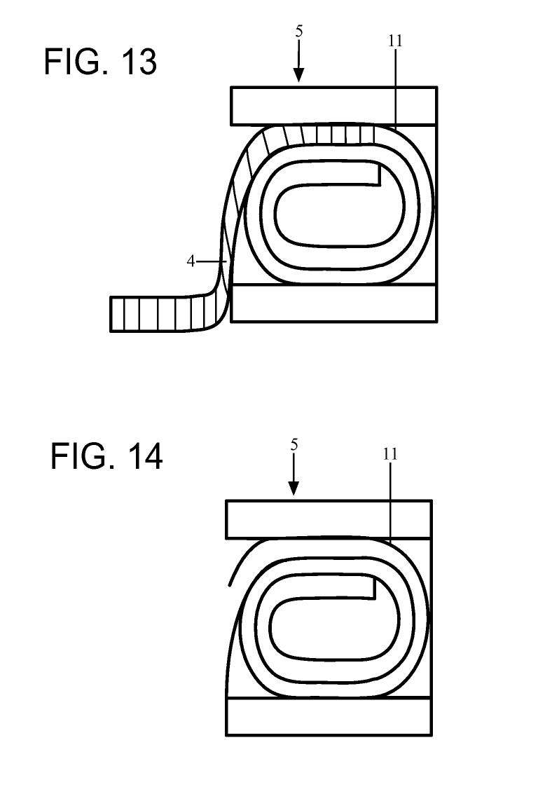

The internal track 11 is fixated within the upper receiving bay 5, and provides the capacity for the sliding shield door 4 to roll into it, which then reveals the LCD screen 2, as shown in FIGS. 13-14. The internal track 11 is a cylinder with a curved track, and is accordingly distributed properly to allow for the sliding shield door 4 to slide into it smoothly. This internal track 11 is essentially a curved guiding track, which connects to guiding track 8R at the meeting point of track 8R and upper receiving bay 5, in slot 9, as depicted in FIG. 12. The track is likewise made of a durable plastic or metal, or any other similar suitable material.

The dimensions of the sliding shield door 4 are variable, being based upon the specification of a given LCD screen 2 of the electronic device in question, and the frame assembly 70, namely including bays 5 & 6 and guiding tracks 7L & 7R will likewise be based on such specifications, accordingly.

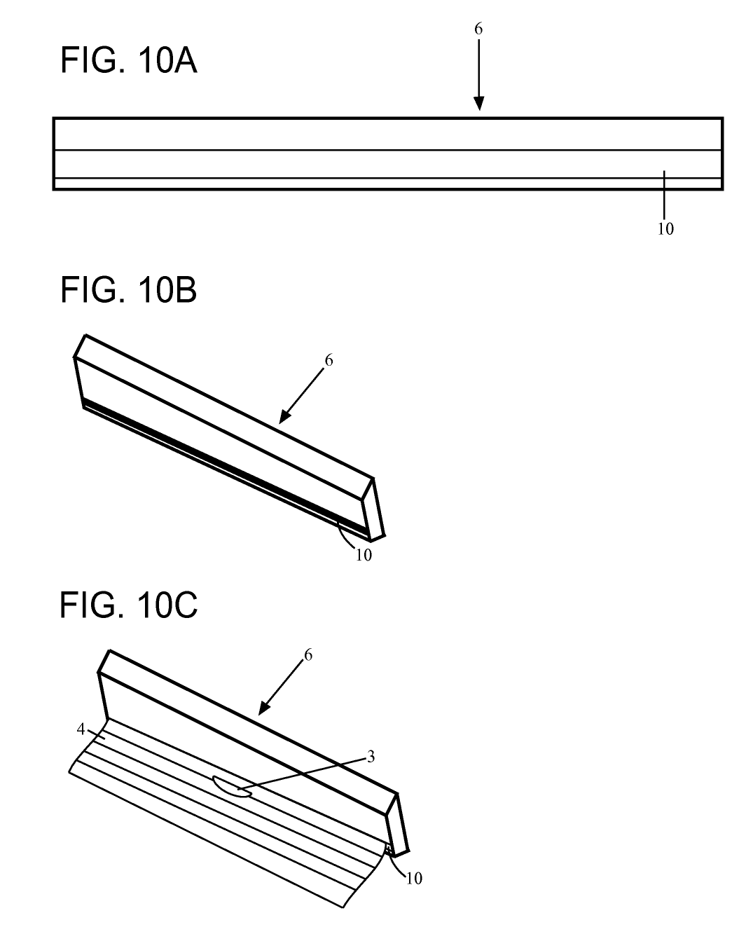

The lower portion of the frame assembly 70 is accordingly met with the lower receiving bay 6, a structure which likewise spans the same width of coverage as the upper receiving bay 8. The lower receiving bay 6 in contrast does not require an internal track 11, and its purpose is to dock with the door 4 once it slides into it. It is likewise slotted in its center, and is hollow inside, allowing for the door 4 to enter and be housed, as well as allowing it to be able to revert to a closed portion, thereby covering the LCD screen 2. FIGS. 10A-10C offer various views of lower receiving bay 6, a square box, with a slot 10 in the center, enabling the door 4 to enter and dock, to assume a closed position. The lower receiving bay 6 is constructed of a durable material such a plastic or a metal, but is not limited to either, and other suitable materials which suffice can be used.

FIGS. 16B-16D illustrate an alternative simple track embodiment. In this embodiment, a rod 12 is fixated to the end of the sliding shield door 4, furthest away from the protruding handle 3, to enable the door 4 to coil around it. The door 4 still slides through both guiding tracks 8L & 8R, and into the upper receiving bay 5. A simple track 13 is fixated into the upper receiving bay 5, enabling the rod 12 which is attached to the door 4 to coil inside of the simple track 13, as shown in FIG. 16B. The rod 12 is made of a durable material such as a plastic or a metal, but is not limited to such materials. The simple track 13 is also made of the same durable material that the internal track 11 is made of, for instance a plastic or a metal, but is not limited to such materials.

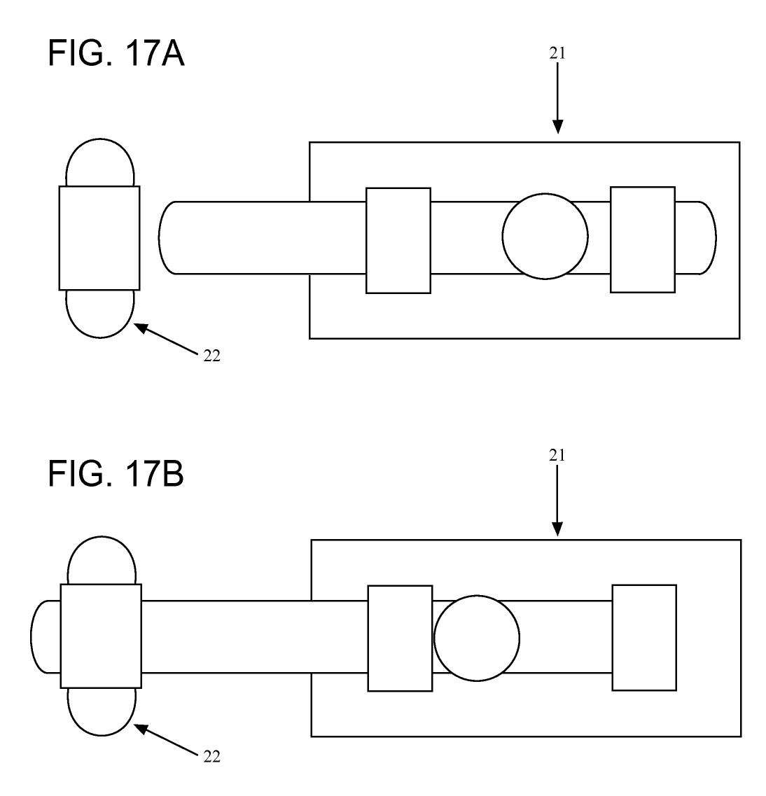

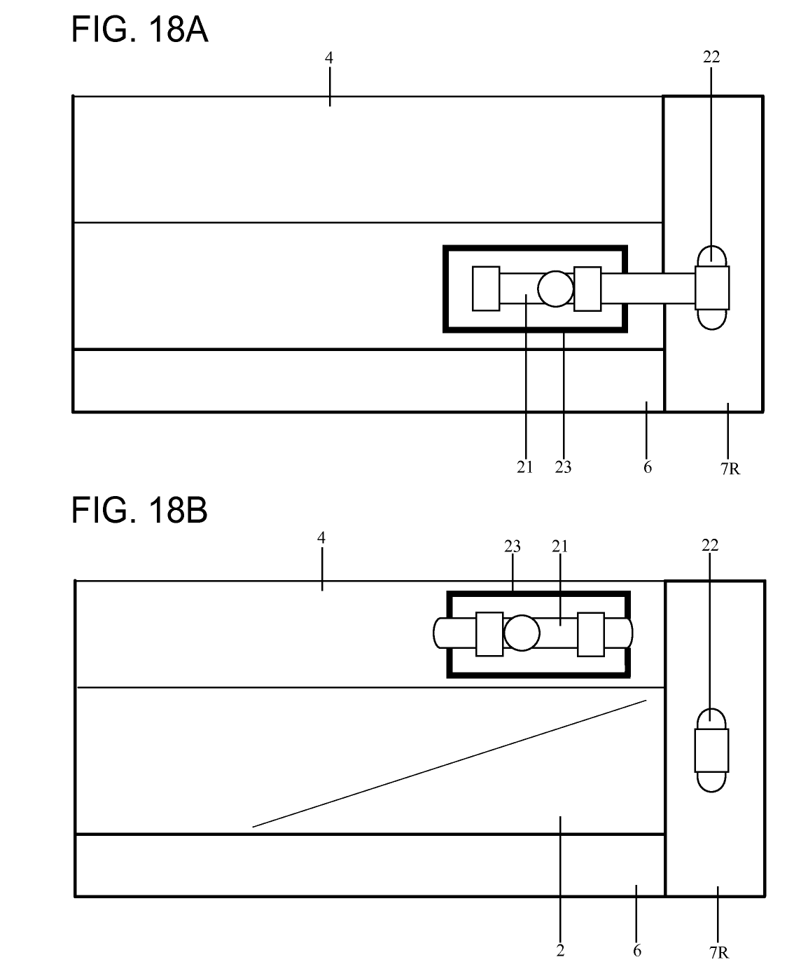

A locking mechanism is fixated to the door 4, which firmly locks the door 4 in place and prevents any unintended opening of the door 4, once the door 4 is docked to the lower receiving bay 6, and is in the closed position. FIGS. 17A-17B illustrate an embodiment of a locking mechanism to firmly secure the shield door 4 when docked with lower receiving bay 6. The embodiment includes a sliding deadbolt 21, preferably molded or mounted on to the sliding shield door 4, which slides into a receiving cap 22, itself preferably mounted or molded on top of guiding track body 7R, as depicted in FIGS. 18A-18B & 20A-20B.

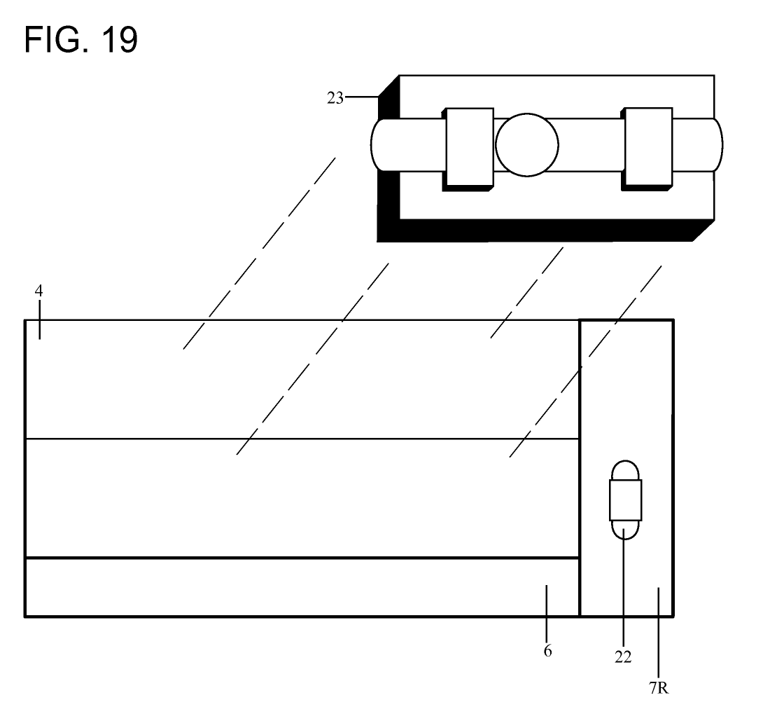

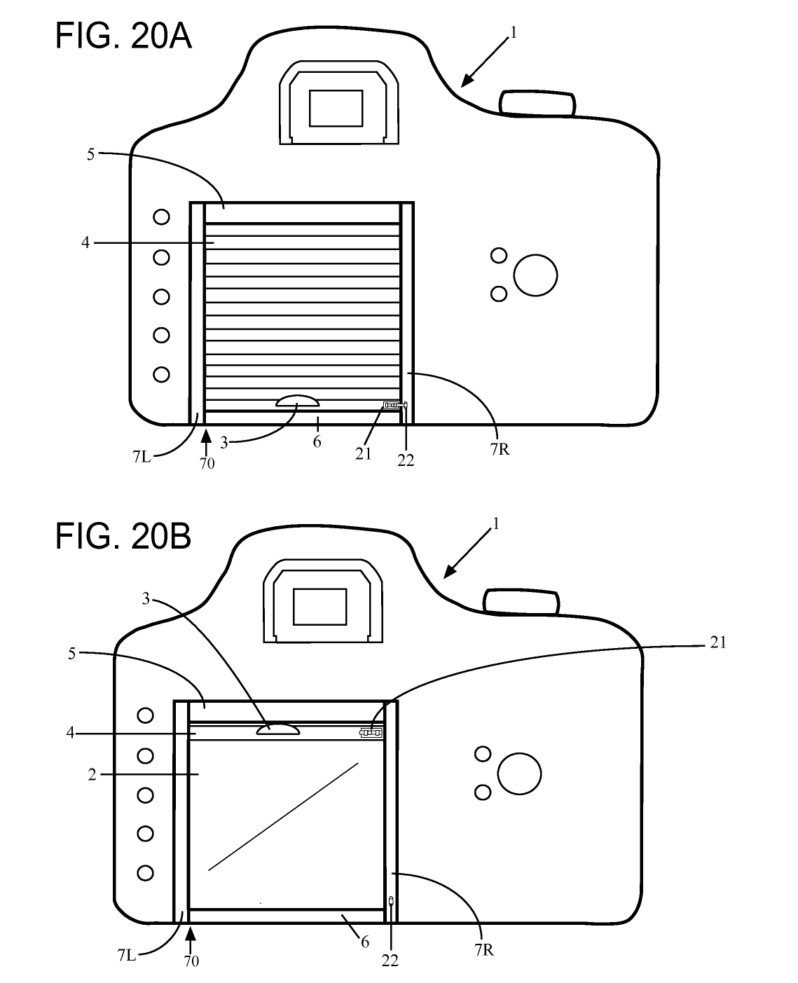

To accommodate any potential height differences between that of the door 4 and of guiding track body 7R, with regards to the sliding deadbolt 21 and receiving cap 22, an elevated platform 23 that can be fitted underneath the base of the sliding deadbolt 21, at a slightly raised elevation that will not interfere with the door 4 docking with bays 5&6. This serves to balance an appropriate level for the sliding deadbolt 21 to enable proper sliding into the receiving cap 22, as shown in the embodiments in both FIGS. 18A-19.

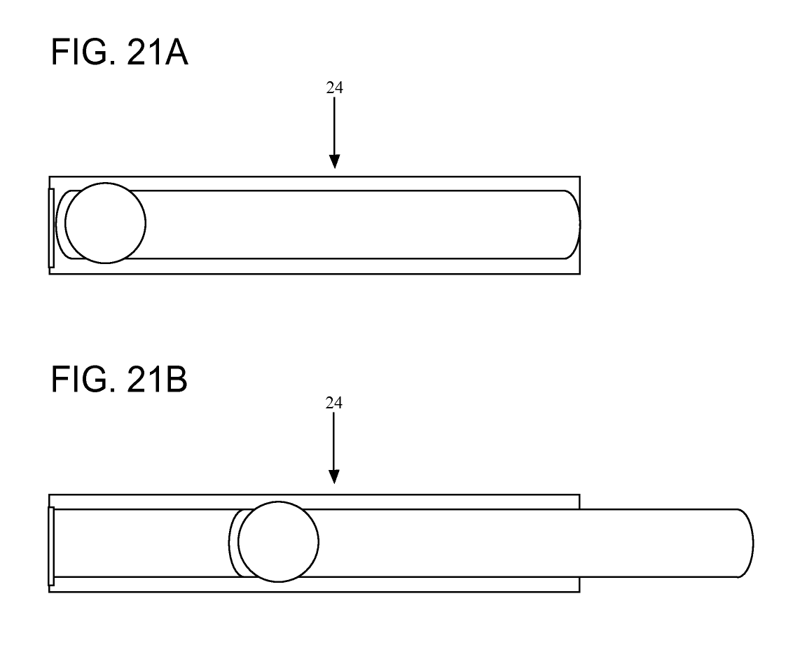

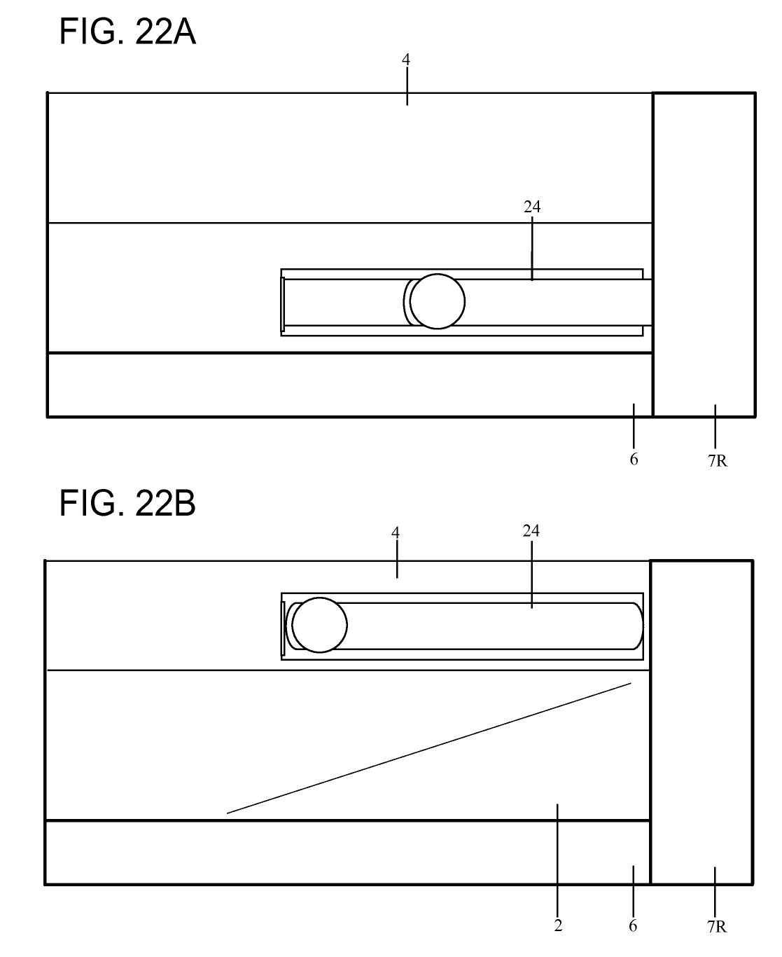

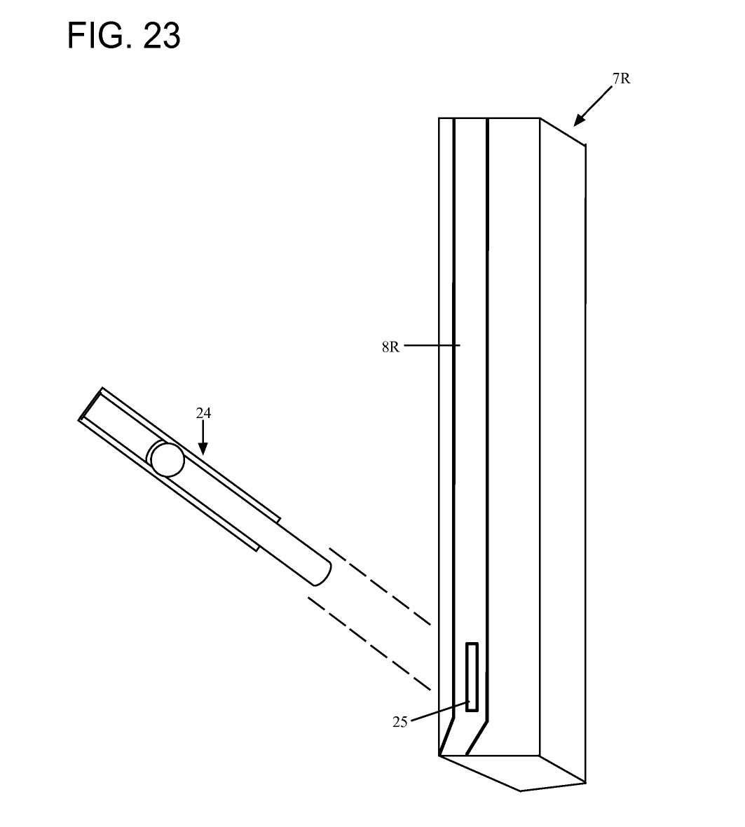

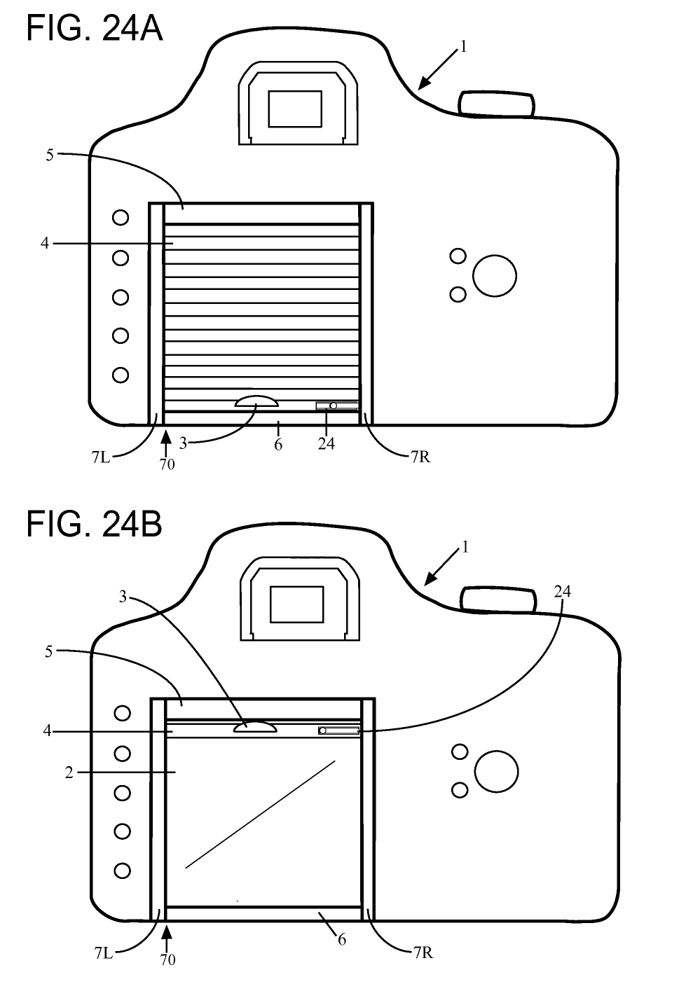

An alternative embodiment of a locking mechanism is exemplified in FIGS. 21A-24B, where a simple sliding deadbolt 24 is utilized to lock the sliding shield door 4 when in the closed position. The simple sliding deadbolt 24 is molded to the door 4, and slides into a slot 25 inserted in the vicinity of guiding track 8B, in this embodiment, within guiding track 8B itself. The slot 25 is a deeply penetrated slot, and the simple sliding deadbolt 24 simply slides into the slot 25, locking the door 4.

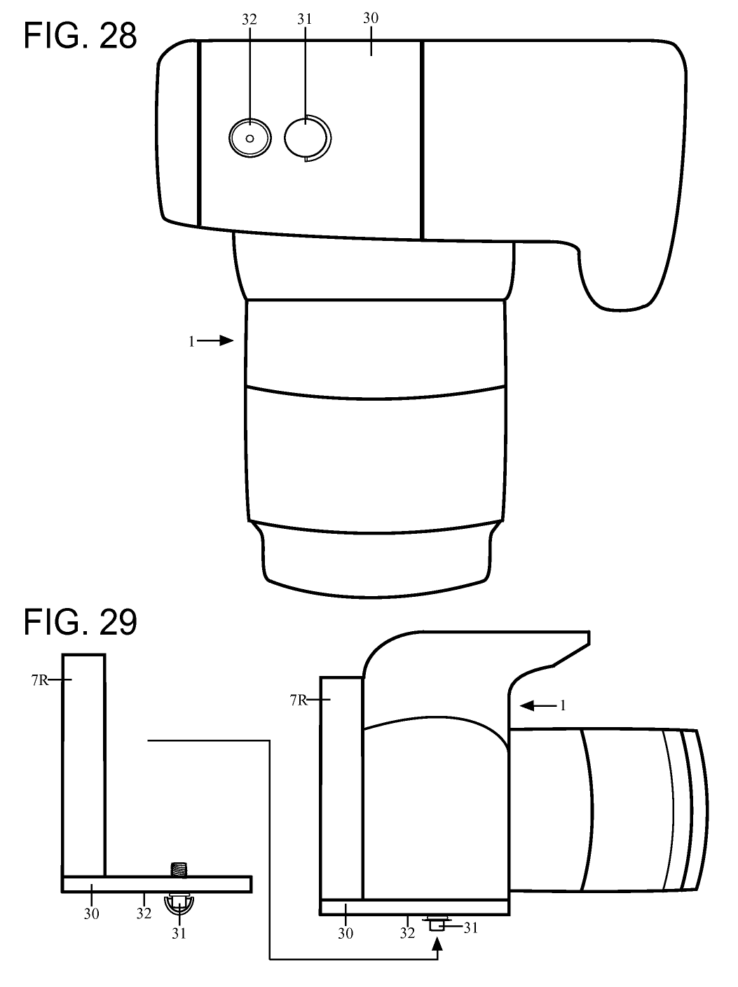

The device attaches to the body of a camera or an electronic device so that it enables the device to be fixated securely on to such a body. In one embodiment, a bottom extension 30 is utilized, which fastens to the bottom of a camera 1, stemming from the lower receiving bay 6. The bottom extension 30 is made of a durable material such as plastic, but is not restricted to such a material, and other similarly suited materials can be used. The bottom extension 30 contains a lock screw 31 which screws in to the existing mounting hole 50 located on the underside of the camera 1 to fasten to it, as depicted in FIGS. 27-29.

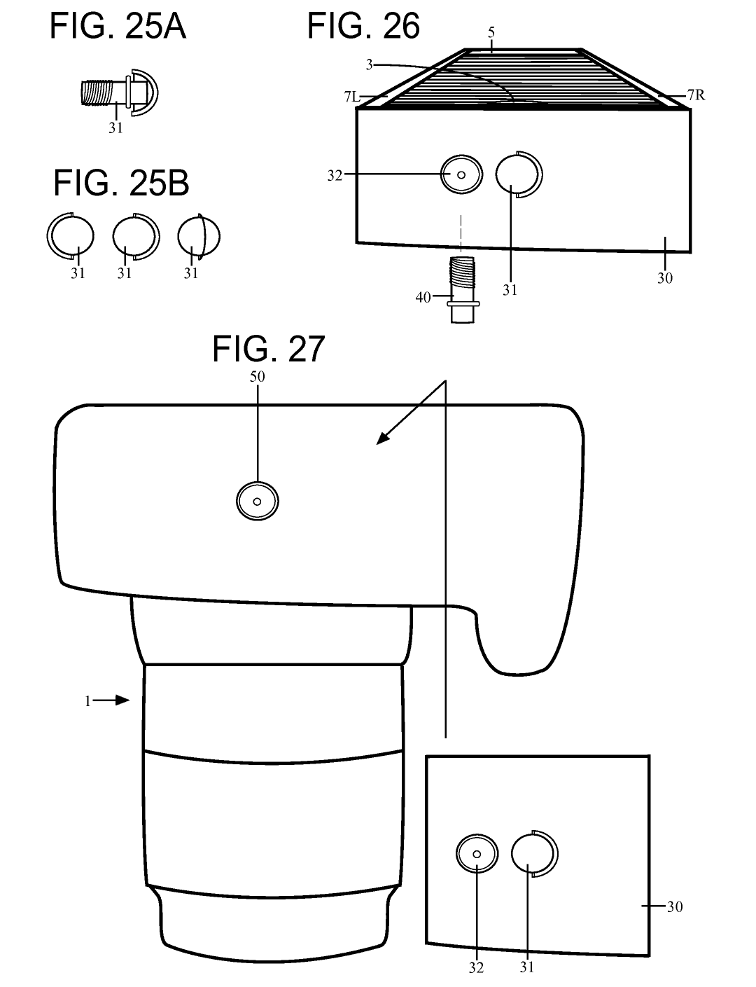

The lock screw 31 has the precise thread dimensions necessary to screw in to the mounting hole 50 of the camera 1, and is preferably in the form of a D-ring screw, with a rotatable top handle that swivels, as depicted in FIGS. 25A-25B. However, the lock screw 31 is not limited or restricted to such a form, and other types of screws can be used.

An auxiliary mounting hole 32, threaded to mimic the dimensions, depth, and thread grooves of the existing mounting hole 50 on the camera 1 is stationed adjacent to the lock screw 31. An external support screw 40 from a support 41 such as a tripod can then be fastened to the auxiliary mounting hole 32, while the camera 1 is simultaneously fastened to the device, as illustrated in FIG. 26. The setup enables the use of a support 41 such as a tripod, without conflicting with the attachment and use of the device.

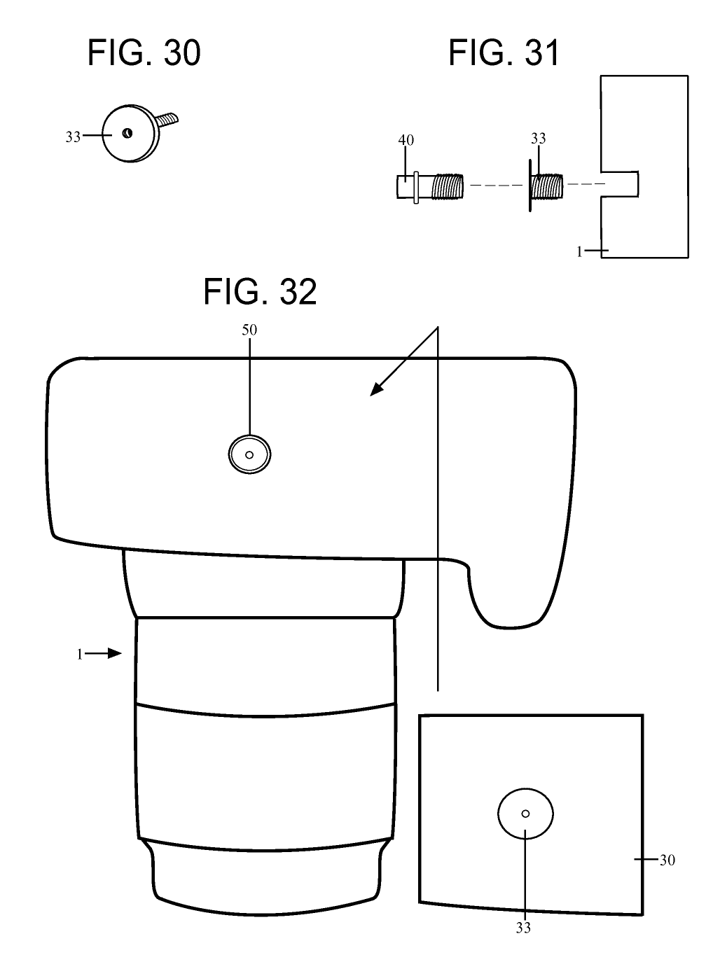

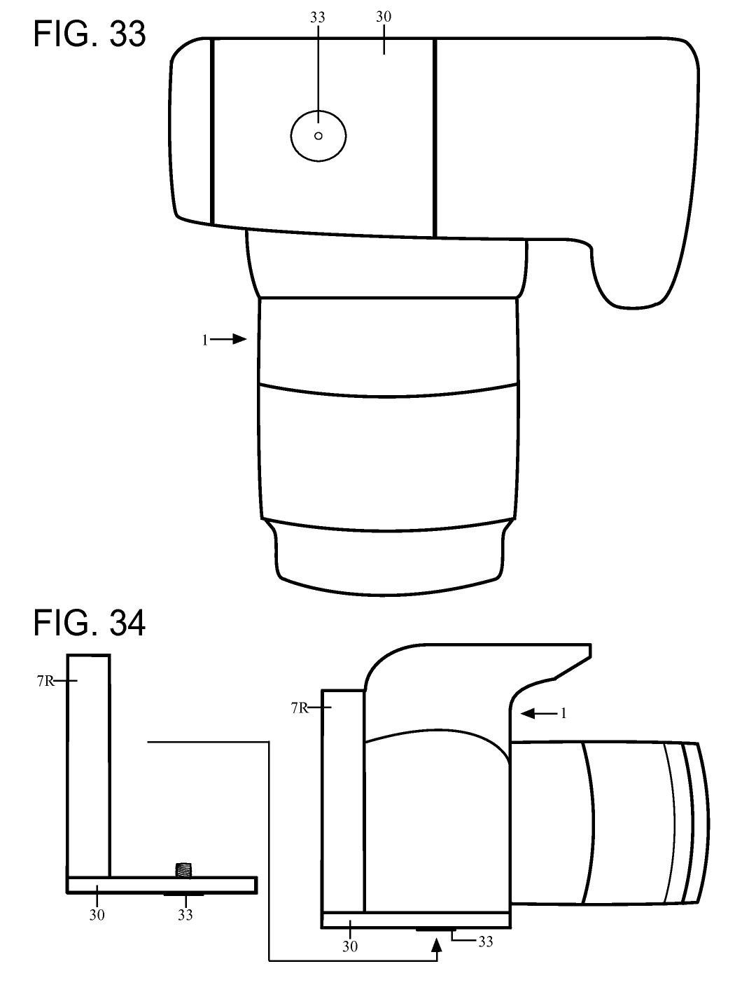

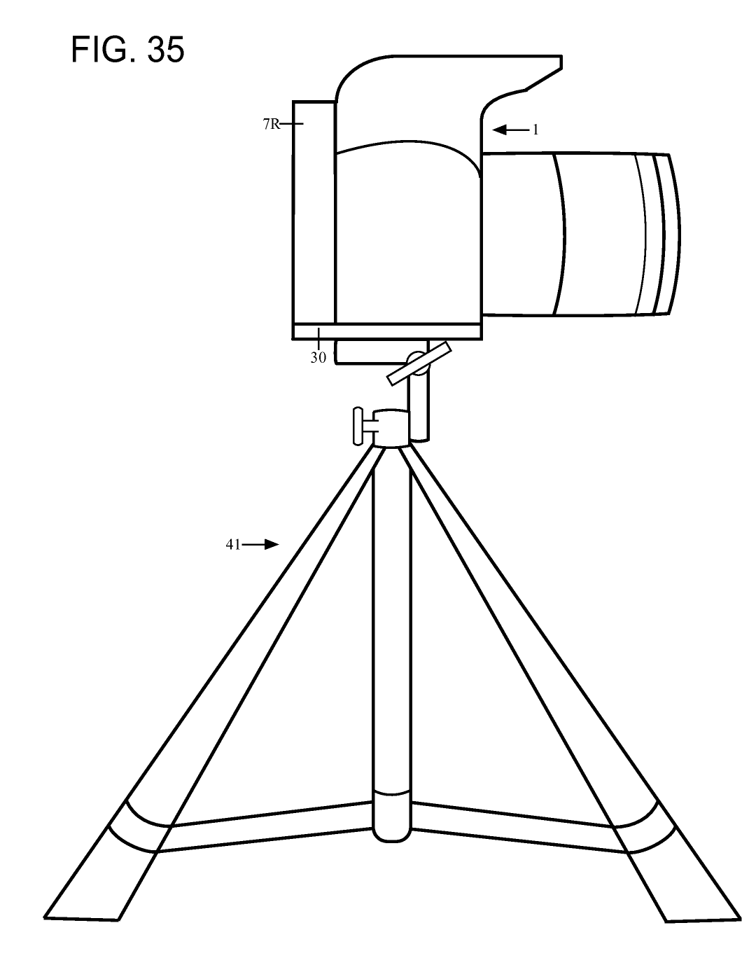

In another embodiment, a mounting screw adapter 33 is utilized, in essence, functioning as both the lock screw 31 and the auxiliary mounting hole 32. As illustrated in FIGS. 31-34, the mounting screw adapter 33 screws into the existing mounting hole 50 of the camera 1, while simultaneously functioning as a female extension, so that a support screw 40 from a support 41 can be fastened directly. As depicted in FIG. 30, the surface head of the mounting screw adapter 33 is a duplicate mounting hole of the existing mounting hole 50 located on the underside of the camera 1, to enable direct attachment of the camera 1 to a support 41, while the thread is the same as that of the lock screw 31, likewise enabling penetration and fastening to the mounting hole 50 of the camera 1. Regardless of which screw method is utilized in such bottom extension embodiments as depicted in FIGS. 26 & 31, the camera 1 nonetheless attaches to a support 41, ultimately the same way in both extension embodiment scenarios, as depicted in FIG. 35.

It is important to note that the attachment methods for the invention are not limited to either embodiments, and other methods for attachment can be utilized. In one embodiment, this is done via an adhesive method, using an adhesive substance 35 such as double sided tape, which is placed on the underside of the frame assembly 70.

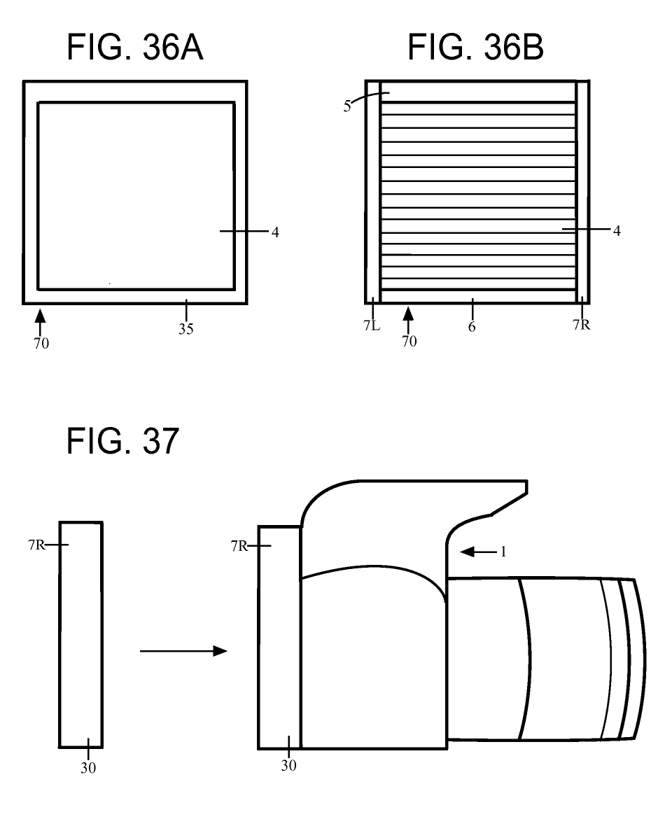

For instance, in cases where a bottom attachment extension is not feasible or desired, or if a more permanent mode of attachment is desired, an adhesive substance 35 can be applied to the underside of the frame assembly 70 in an alternative attachment embodiment. In such an embodiment, as depicted in FIGS. 36A-37, an adhesive substance 35 is placed on the surface of receiving bays 5 & 6, and guiding track bodies 7L & 7R. The adhesive substance 35 is preferably a double sided tape, or a coatable adhesive residue, but is not limited to such materials, and any similar suitable material which is sufficiently adhesive can be used. The invention is not limited to such an adhesive embodiment, nor is it limited to an adhesive method, and non-adhesive methods for attachment such as those described earlier can also be utilized.

Although the afore mentioned descriptions contain many specificities, these specificities should not be viewed as limiting the scope of the embodiments, but rather as merely providing illustrations of several embodiments. It is to be understood that the described invention is not to be limited by the specific embodiments mentioned herein, and that changes, alterations, and modifications may be made, within the scope and essence of the described concepts. The scope of the embodiments therefore should be determined by the following claims:

What is claimed is:

1. An apparatus for protecting a display screen of an electronic device, comprising:
a frame assembly configured to be connected over a display screen of an electronic device, said frame assembly including a front side and a rear side, a left side guiding track member having upper and lower ends, a right side guiding track member having upper and lower ends, an upper receiving bay connected between said upper ends of said left and right side guiding track members, and a lower receiving bay connected between said lower ends of said left and right side guiding track members, said left and right side guiding track members each having a surface defining opposing slots forming left and right side guiding tracks, respectively, said upper and lower receiving bays each including a surface defining opposing upper and lower slots, respectively, and each of said opposing upper and lower slots being connected with said left and right side guiding tracks; and
a rollable shield door having left and right sides and upper and lower ends, said left and right sides of said rollable shield door being slidably received in said left and right side guiding tracks of said frame assembly and configured to move between an open configuration and a closed configuration, at least a major portion of said rollable shield door being configured to bend to be received and rolled in said upper receiving bay in said open configuration, and at least a portion of said lower end of said rollable shield door being received in said lower receiving bay in said closed position.

2. The apparatus of claim 1, wherein said upper receiving bay has left and right sides, and said upper receiving bay comprises an internal track formed inside at least one of said left and right sides of the upper receiving bay, and said internal track is connected with at least one of said left and right side guiding tracks.

3. The apparatus of claim 1, wherein said rollable shield door comprises a handle on a front side of said rollable shield door.

4. The apparatus of claim 1, further comprising a lock mounted to said rollable shield door, said lock including a sliding deadbolt locking bar slidably movable between a locked position and an unlocked position, said sliding deadbolt locking bar slidably engaging a corresponding aperture defined on one of said left and right side guiding track members in said locked position when said at least a portion of said lower end of said rollable shield door is received in said lower receiving bay in said closed position.

5. The apparatus of claim 1, further comprising a clear protective sheet mounted to a front side of said left and right side guiding track members and disposed between said left and right side guiding track members and said rollable shield door.

6. An apparatus for protecting a display screen of an electronic device, comprising:
a frame assembly configured to be connected over a display screen of an electronic device, said frame assembly including a front side and a rear side, a left side guiding track member having upper and lower ends, a right side guiding track member having upper and lower ends, an upper receiving bay connected between said upper ends of said left and right side guiding track members, and a lower receiving bay connected between said lower ends of said left and right side guiding track members, said left and right side guiding track members each having a surface defining opposing slots forming left and right side guiding tracks, respectively, said upper and lower receiving bays each including a surface defining opposing upper and lower slots, respectively, each of said opposing upper and lower slots being connected with said left and right side guiding tracks, said upper receiving bay having left and right sides, said upper receiving bay including an internal track formed inside at least one of said left and right sides of the upper receiving bay, and said internal track being connected with at least one of said left and right side guiding tracks; and
a rollable shield door having left and right sides and upper and lower ends, said left and right sides of said rollable shield door being slidably received in said left and right side guiding tracks of said frame assembly and configured to move between an open configuration and a closed configuration, at least a major portion of said rollable shield door being configured to bend to be received and rolled in said upper receiving bay in said open configuration, and at least a portion of said lower end of said rollable shield door being received in said lower receiving bay in said closed position.

7. The apparatus of claim 6, wherein said internal track is molded inside at least one of said left and right sides of the upper receiving bay.

8. The apparatus of claim 6, wherein said internal track is a curved guiding track.

9. The apparatus of claim 1, wherein said rollable shield door comprises outwardly protruding handle on a front side of said rollable shield door.

10. The apparatus of claim 1, further comprising a lock mounted to said rollable shield door, said lock including a sliding deadbolt locking bar slidably movable between a locked position and an unlocked position, said sliding deadbolt locking bar slidably engaging a corresponding aperture defined on one of said left and right side guiding track members in said locked position when said at least a portion of said lower end of said rollable shield door is received in said lower receiving bay in said closed position.

11. The apparatus of claim 1, further comprising a clear protective sheet mounted to a front side of said left and right side guiding track members and disposed between said left and right side guiding track members and said rollable shield door.

12. The apparatus of claim 1, wherein said frame assembly is configured to be connected to an electronic device by adhesive.

13. The apparatus of claim 1, wherein said frame assembly is configured to be connected to an electronic device by a bottom extension connected to said lower receiving bay, said bottom extension including a lock screw which screws into an existing mounting hole of the electronic device.

14. An apparatus for protecting a display screen of an electronic device, comprising:
a frame assembly configured to be connected over a display screen of an electronic device, said frame assembly including a front side and a rear side, a left side guiding track member having upper and lower ends, a right side guiding track member having upper and lower ends, an upper receiving bay connected between said upper ends of said left and right side guiding track members, and a lower receiving bay connected between said lower ends of said left and right side guiding track members, said left and right side guiding track members each having a surface defining opposing slots forming left and right side guiding tracks, respectively, said upper and lower receiving bays each including a surface defining opposing upper and lower slots, respectively, each of said opposing upper and lower slots being connected with said left and right side guiding tracks, said upper receiving bay having left and right sides, said upper receiving bay including an internal track molded inside at least one of said left and right sides of the upper receiving bay, and said internal track being connected with at least one of said left and right side guiding tracks; and
a rollable shield door having left and right sides and upper and lower ends, said left and right sides of said rollable shield door being slidably received in said left and right side guiding tracks of said frame assembly and configured to move between an open configuration and a closed configuration, at least a major portion of said rollable shield door being configured to bend to be received and rolled in said upper receiving bay in said open configuration, and at least a portion of said lower end of said rollable shield door being received in said lower receiving bay in said closed position.

15. The apparatus of claim 14, wherein said internal track is a curved guiding track.

16. The apparatus of claim 14, wherein said rollable shield door comprises outwardly protruding handle on a front side of said rollable shield door.

17. The apparatus of claim 14, further comprising a lock mounted to said rollable shield door, said lock including a sliding deadbolt locking bar slidably movable between a locked position and an unlocked position, said sliding deadbolt locking bar slidably engaging a corresponding aperture defined on one of said left and right side guiding track members in said locked position when said at least a portion of said lower end of said rollable shield door is received in said lower receiving bay in said closed position.

18. The apparatus of claim 14, further comprising a clear protective sheet mounted to a front side of said left and right side guiding track members and disposed between said left and right side guiding track members and said rollable shield door.

19. The apparatus of claim 14, wherein said frame assembly is configured to be connected to an electronic device by adhesive.

20. The apparatus of claim 14, wherein said frame assembly is configured to be connected to an electronic device by a bottom extension connected to said lower receiving bay, said bottom extension including a lock screw which screws into an existing mounting hole of the electronic device.
